(19) United States
(12) Patent Application Publication
(10) Pub. No.: US 2025/0384083 A1
(43) Pub. Date: Dec. 18, 2025

(54) Summarizing and Controlling Delivery of Recommended Items

(71) Applicant: Microsoft Technology Licensing, LLC, Redmond, WA (US)

(72) Inventors: Zhiqing HONG, Bellevue, WA (US); Yuhan SUN, Lynnwood, WA (US); Wan Jia Kun ZHU, Seattle, WA (US)

(73) Assignee: Microsoft Technology Licensing, LLC, Redmond, WA (US)

(21) Appl. No.: 18/769,111

(22) Filed: Jul. 10, 2024

Related U.S. Application Data
(60) Provisional application No. 63/659,845, filed on Jun. 14, 2024.

(51) Int. Cl. G06F 16/683; G06F 40/166; G06F 40/284; G06F 40/40; G10L 13/02

(52) U.S. Cl. CPC G06F 16/683; G06F 40/166; G06F 40/284; G06F 40/40; G10L 13/02

(57) ABSTRACT

A technique is described herein for controlling the delivery of a personalized selection of items. In some implementations, the technique includes: receiving a sequence of text items that are chosen by a recommendation model based on characteristics of a particular user; interacting with a language model to successively create summaries of the sequence of text items, to provide a sequence of summaries; successively generating instances of output information for the sequence of summaries; and presenting the instances of output information. In some implementations, the instances of output information are instances of audio information which collectively make up a personalized audio podcast. The technique presents a preparatory item (e.g., a music-containing item) upon determining that a buffer memory does not yet store a next instance of audio information for a next summary. This provisional reduces pauses in the outputting of the instances of output information.

This application claims the benefit of U.S. Provisional Application No. 63/659,845 (the '845 Application), filed on Jun. 14, 2024. The '845 Application is incorporated by reference herein in its entirety.

### BACKGROUND

Traditional podcasts and newsletters involve the generation of a single fixed collection of media items, followed by the delivery of these media items to end users. Attempts at expanding and enriching this technology run the risk of degrading the efficiency at which the media items are generated and provided to the end users, and/or compromising the quality of the presentation of the media items.

### SUMMARY

A technique is described herein for controlling the delivery of a personalized selection of items. In some implementations, the technique includes: receiving a sequence of text items that are chosen by a recommendation model based on characteristics of a particular user or other entity; interacting with a language model to successively create summaries of the sequence of text items, to provide a sequence of summaries; successively generating instances of output information for the sequence of summaries; and presenting the instances of output information.

In some implementations, the instances of output information are instances of audio information, which collectively make up a personalized audio podcast. Alternatively, or in addition, the instances of output information are text sections of a personalized textual compendium, such as a newsletter.

According to another illustrative aspect, the technique presents a preparatory item upon determining that a buffer memory does not yet store an instance of output information for a next summary in a sequence of summaries to be presented. A preparatory item is content that is presented while the output information for other content is being prepared. For instance, the preparatory item is a music-containing item, or document of any kind.

According to another illustrative aspect, the technique includes, prior to the generating of the output information for a first summary: obtaining weather data from a source of weather information; interacting with the language model to produce a text narrative based on the weather data; and generating and presenting output information for the narrative.

According to another illustrative aspect, the technique includes, in response to a control instruction, obtaining a supplemental text item that is semantically related to a current summary that is being presented or has been presented; interacting with the language model to create a summary of the supplemental text item; and generating and presenting output information for the summary.

According to another illustrative aspect, the technique includes receiving notification information that provides a notice that an event has occurred; and interrupting the presentation of the summaries to generate and present output information for the notification information.

According to another illustrative aspect, the technique chooses a number of text items and/or the length of each summary based on a target duration of a trip during which the summaries will be presented.

According to another illustrative aspect, the technique presents output information for at least one comment associated with a text item. Alternatively, or in addition, the technique receives a comment from the user and appends the comment to the text item.

According to illustrative technical benefits, the technique uses a single platform to deliver several personalized streams of media items. The technique is scalable in this regard compared to a platform that uses different workflows and functionalities to generate and deliver different streams of media items. A single platform is also more resource efficient compared to a platform that uses different workflows and functionalities. Further, the technique reduces occurrences of dead air (for example, silences) in the presentation of items. The technique achieves this effect by presenting music or other supplemental content while the items are being prepared.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a content delivery system for generating and delivering personalized items.

FIGS. 2 and 3 are flowcharts that show an illustrative flow of operations performed by the content delivery system of FIG. 1.

FIG. 4 is a flowchart that shows how the content delivery system of FIG. 1 responds to different control instructions.

FIG. 5 is a flowchart that shows how the content delivery system of FIG. 1 responds to an event of interest, such as a traffic incident.

FIG. 6 shows a map of a route that identifies one circumstance that causes the content delivery system of FIG. 1 to produce a notification.

FIG. 7 is a flowchart that shows how the content delivery system of FIG. 1 receives and processes a comment provided by a user.

FIG. 8 shows an example of a sequence of personalized audio presentations produced by the content delivery system of FIG. 1, which collectively make up an audio podcast.

FIG. 9 shows an example of a collection of text summaries produced by the content delivery system of FIG. 1, which collectively make up a personalized newsletter.

FIG. 10 shows an illustrative language model for implementing various functions of the content delivery system of FIG. 1.

FIG. 11 is a flowchart that provides an overview of one manner of operation of the content delivery system of FIG. 1.

FIG. 12 is a flowchart that provides an overview of another manner of operation of the content delivery system of FIG. 1.

FIG. 13 shows computing equipment that, in some implementations, is used to implement the content delivery system of FIG. 1.

FIG. 14 shows an illustrative type of computing system that, in some implementations, is used to implement any aspect of the features shown in the foregoing drawings.

The same numbers are used throughout the disclosure and figures to reference like components and features.

### DETAILED DESCRIPTION

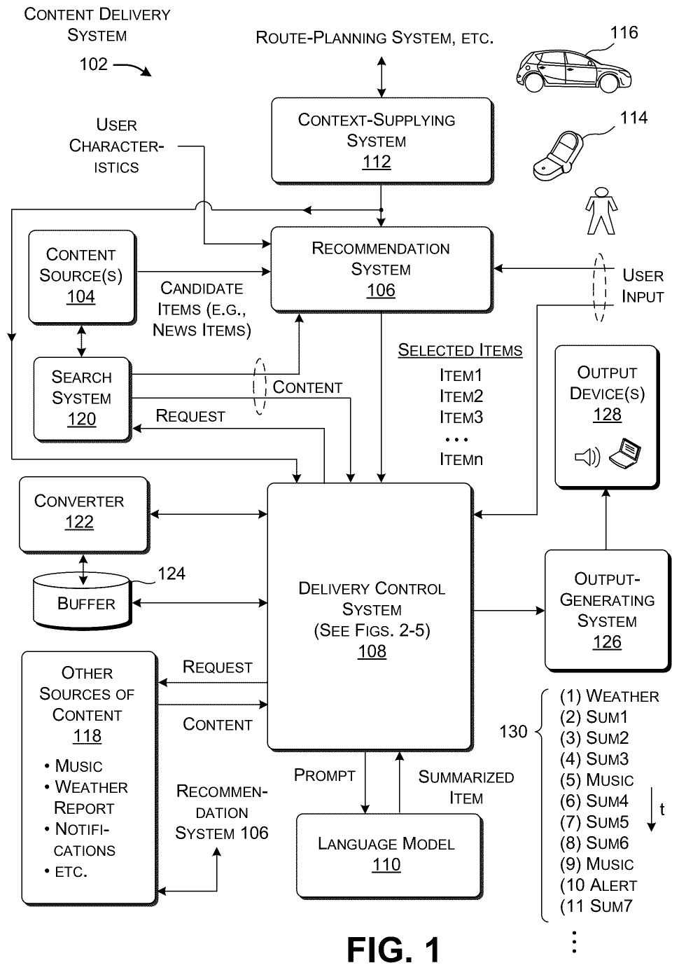

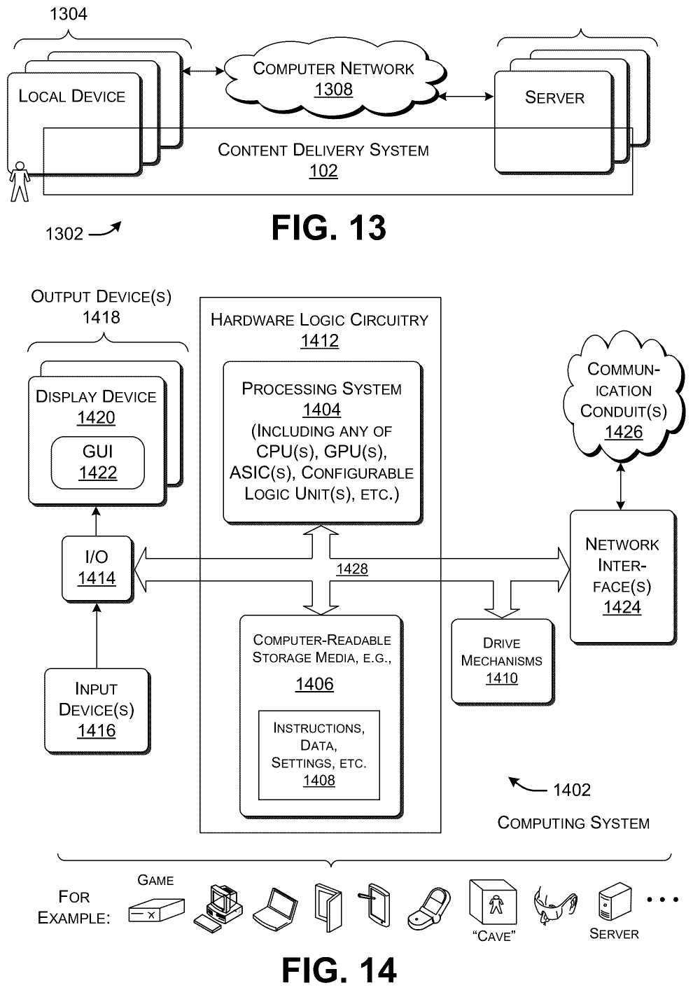

FIG. 1 shows a content delivery system 102 for generating and delivering personalized items. The following terminology is relevant to some examples presented below. In an example, an “item” is digital content that includes text. For example, an item is a digital news article that is posted as a web page and accessible via a browser. In an example, a “machine-trained model” or “model” refers to computer-implemented logic for executing a task using machine-trained parameters that are produced in a training operation. In an example, a “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. In an example, a “prompt” refers to a sequence of tokens submitted to a machine-trained model. In an example, a “distributed vector” expresses the semantic content of an information item by distributing information over its k dimensions. A distributed vector is in contrast to a sparse one-hot vector that allocates particular dimensions of the vector to particular concepts. In some contexts, terms such as “component,” “module,” “engine,” and “tool” refer to parts of computer-based technology that perform respective functions. FIGS. 13 and 14, described below, provide examples of illustrative computing equipment for performing these functions.

The content delivery system 102 operates on candidate items from one or more sources 104. For example, the sources 104 are one or more repositories of digital news articles associated with Uniform Resource Locators (URLs) and accessible by a browser via the Internet. Alternatively, or in addition, the sources 104 are one or more repositories of locally-stored news articles. Reference to news articles is illustrative; other implementations extend the principles set forth here to other information domains.

A recommendation system 106 uses a machine-trained recommendation model to choose a set of items from the candidate items provided by the source(s) 104 that best match characteristics of a user or other entity. Different implementations of the recommendation system 106 perform this task in different ways. In a dual encoder approach, the recommendation system 106 generates a first feature vector having features that describe the user. The recommendation system 106 generates a second feature vector having features that describe a candidate item provided by the source(s) 104. The recommendation system 106 uses a neural network to map the first and second feature vectors to first and second hidden state vectors in a common vector space. The recommendation system 106 then uses any distance metric (such as cosine similarity) to determine the similarity between the first and second hidden state vectors. Overall, the recommendation system 106 chooses a set of items having the most favorable similarity scores.

The features in the first feature vector describe various characteristics of the user, including any of the as the user's demographic characteristics, the user's current location, the user's prior selections of items, etc. The features in the second feature vector describe various characteristics of the candidate item under consideration, including any of the title of the item, the keywords associated with the item, the selection history of the item, the entire content of the item, etc.

In a cross-encoder approach, the recommendation system 106 concatenates the first feature vector and the second feature vector, to form joint input information. The cross-encoder model then uses a transformer-based model (such as a BERT-based model) or other neural network to map the joint input information to a score that reflects an extent to which the candidate item under consideration matches the characteristics of the user. As before, the recommendation system 106 chooses a set of items having the most favorable similarity scores. General background information regarding the BERT model itself is available at Devlin, et al., “BERT: Pre-training of Deep Bidirectional Transformers for Language Understanding,” arXiv, arXiv:1810.04805v2 [cs.CL], May 24, 2019, 16 pages.

In a general-purpose language model approach, the recommendation system 106 generates a prompt that describes a candidate item and user characteristics, together with text that instructs a general purpose language model to provide a response that specifies whether the candidate item is a good match for the user. Examples of language models are described below. The above recommendation models are illustrative; the recommendation system 106 can use yet other models.

In some implementations, the recommendation system 106 also orders the selected set of items in a prescribed order, to form a sequence of items. For example, the recommendation system 106 orders the selected set of items from the items with the most favorable similarity scores to items with the least favorable similarity scores. Alternatively, or in addition, the recommendation system 106 organizes the selected items based on a predetermined template. That predetermined template can define different groupings of subject matter domains arranged in a prescribed order.

A delivery control system 108 processes the set of items supplied by the recommendation system 106 to deliver the items to the user. For example, the delivery control system 108 interacts with a language model (LLM) 110 to generate a summary of each item provided by the recommendation system 106. Overall, this results in a sequence of summaries associated with the respective items. In some implementations, the delivery control system 108 converts each summary to audio information as it is generated, and then delivers the audio information for the summary to the user, e.g., via a speaker provided by a mobile computing device 114 or other receiving device. This results in a sequence of instances of audio information provided to the user, which collectively make up an audio podcast. In other implementations, the delivery control system 108 delivers the sequence of summaries to the user in text form. For example, the delivery control system 108 assembles text sections associated with respective summaries into a newsletter. To facilitate explanation, however, most of the examples presented herein will assume the former case, in which the delivery control system 108 provides the summaries to the user in audio form.

The language model 110 is a machine-trained model that, in some examples, autoregressively transforms an input prompt into a response. Autoregressively means token-by-token; that is, as the language model 110 generates a new token, that new token is appended to the end of the current sequence of tokens, and the updated sequence of tokens is used to generate the next token. This process continues until the language model 110 produces a stop token, which signals that its response is complete.

In some contexts, the input prompt includes a system part that instructs the language system 106 to summarize text in a particular way. For example, the system part includes text that specifies, “Summarize the following text <text> to make it easier to repeat out as a radio podcast,” in which <text> is a reference to the text of information to be summarized (here, a news item). Another part of the system prompt may specify a target language, style, etc. that the language model 110 is to use to generate each summary. In some implementations, the text to be summarized includes a single item. The delivery control system 108 makes successive calls to the language model 110 to produce summaries of a sequence of items. Alternatively, the text to be summarized includes plural items sent to the language model 110 at the same time. In this case, the language model 110 may be configured to sequentially output the completed summaries all at once, in blocks of plural items, or one at a time.

In some implementations, the language model 110 is any commercially available language model, such as any model in the family of GPT models (such as GPT 3.5 Turbo) provided by OpenAI of San Francisco, California. Another example of a language model is described in Scao, et al., “BLOOM: A 176B-Parameter Open-Access Multilingual Language Model,” arXiv, arXiv: 2211.05100v2 [cs.CL], Dec. 11, 2022, 62 pages. A smaller language model, having a few billion parameters, is described in Touvron, et al., “LLaMA: Open and Efficient Foundation Language Models,” arXiv, arXiv: 2302.13971v1 [cs.CL], Feb. 27, 2023, 27 pages.

In some implementations, the language model 110 is general purpose in a nature, and not specifically trained to perform any specific tasks. In other examples, the language model 110 is fine tuned to perform a summarization task, starting with a set of pretrained parameters. For instance, a training system (not shown) uses supervised or semi-supervised learning to iteratively adjust parameters of the language model 110 so that responses produced by the language model 110 match ground-truth responses (given a priori) with increasing degrees of exactness. The training system uses any distance metric to measure the similarity between two responses, such as cosine similarity. The training system uses any loss function to measure overall loss for a plurality of training examples, such as cross entropy. In some implementations, the training system uses stochastic gradient descent in combination with back propagation to update the parameters of the language model 110 based on the output of the loss function. (Note that, in some examples, the training system applies the same approach to train the recommendation model 106, with the exception being that the training system operates on a different set of training examples, e.g., each of which specifies a tuple of a candidate item, user characteristics, and a ground-truth label that indicates whether the candidate item is a good match for the user characteristics.)

In still other implementations, the content delivery system 102 uses another type of machine-trained model to summarize a candidate item, that is, other than the types of language models described above that operate by autoregressively generating output responses. For example, the content delivery system 102 uses a BERT-based model to generate a score of each sentence of a candidate item, which specifies whether the sentence should be included in the summary. Other technologies for performing summarizing are described in Dong, Yue, “A Survey on Neural Network-Based Summarization Methods,” arXiv, arXiv: 1804.04589v1 [cs.CL], Mar. 19, 2018, 16 pages.

In some implementations, the delivery control system 108 chooses a length of a podcast or other kind of presentation (e.g., a newsletter) to present to the user based on one or more factors. For example, the delivery control system 108 chooses the length based on a configuration setting made by an administrator or a user. Alternatively, or in addition, a context-supplying system 112 determines a current context in which the user is currently interacting with the content delivery system 102. The delivery control system 108 chooses the number of items and/or the length of each summary based on context information provided by the context-supplying system 112. These two parameters determine the overall duration of the podcast or other presentation. The delivery control system 108 can perform this function by consulting a lookup table, e.g., which maps a particular context X to a particular number of items N to be summarized and a length L of each summary.

More specifically, in some implementations, the context-supplying system 112 determines a setting in which the user is currently located. For example, the context-supplying system 112 receives information regarding a user's current location from a global positioning system (GPS) device provided by the mobile computing device 114 (e.g., a smartphone) that accompanies the user. The context-supplying system 112 uses the current location to determine the type of environment in which the user is currently located, such as a work environment or home environment. The delivery control system 108 then consults a lookup table to determine the length of a podcast that is appropriate for the user's current environment.

In another example, the context-supplying system 112 interacts with a route-planning system that indicates that the user is currently traversing a route having a prescribed length and duration, or is about to traverse that route. Or the context-supplying system 112 infers the type of trip that the user is taking based on the user's prior travel habits and the current context. In either case, the delivery control system 108 chooses a number of items and/or the length of each summary so that the total duration of the podcast matches the duration of the trip. This is a non-exhaustive list of duration-selecting strategies. In other examples, the delivery control system 108 plays a non-ending loop of content, and relies on the user to explicitly terminate the loop. In other examples, the delivery control system 108 repeats a personalized podcast of fixed duration (such as two hours) throughout the day. The podcast is changed on a daily basis or on any on other frequency.

In some examples, the delivery control system 108 interacts with other sources 118 of content in the course of producing a sequence of summaries for consumption by the user. For example, as an initial task, the delivery control system 108 obtains weather data from a source of weather information. The weather data pertains to the current location of the user, which is provided by the context-supplying system 112. More specifically, the weather data identifies the current temperature, humidity, wind speed and direction, sunrise, sunset, etc. The delivery control system 108 then requests the language model 110 to produce a narrative based on the weather data, e.g., using the prompt “Create a short radio-like weather forecast (no more than 100 words) based on the JSON data <JSON Data>,” where <JSON Data> is a reference to the weather data expressed in the JSON format. The delivery control system 108 uses the resultant response as a first entry in the radio podcast.

In another example, the delivery control system 108 retrieves a music-containing item (e.g., a song or jingle or sound effect) from a source of music-containing items. In one control setting, the delivery control system 108 injects a music-containing item after serving every p summaries of news items, where p is a configuration parameter. In other examples, the delivery control system 108 plays a music-containing item while it is busy performing other tasks, such as the generation of audio information for a recommended news item. This type of item is referred to herein as a preparatory item because it is played while other content is being prepared. Other examples of supplemental content include ad-related content, document content of any kind, message content, etc.

The other sources of content 118 include selection functionality (not shown) that selects supplemental items in advance and converts the supplemental items into output information (such as audio information). This action allows the delivery control system 108 to immediately begin presenting the supplemental items when needed. In some examples, the selection functionality selects supplemental items of general interest in a manner that is agnostic to the particular user who is currently interacting with the content delivery system 102. In other examples, the selection functionality interacts with the recommendation system 106 to retrieve supplemental items that complement the interests of the user. For instance, the selection functionality selects music-containing items based on knowledge of the user's prior selections of music and other behavior that is suggestive of the user's musical tastes. The selection functionality selects and pre-generates personalized ads in the same manner.

In some implementations, the selection functionality refreshes the list of supplemental items to present to the user on a user-configurable periodic basis, such as every week. In all cases, the supplemental items are considered preselected content that is primed for immediate delivery to the user. This preselected content can be expected to be a less dynamic reflection of current events compared to the stream of news items received from the recommendation system 106.

In another example, a notification system proactively sends notification information to the delivery control system 108 upon the occurrence of an incident. For example, assume that the user is currently traveling in the vehicle 116. The notification system identifies an event within a prescribed distance of the vehicle's current location, and sends notification information to the delivery control system 108 that notifies the delivery control system 108 of same. Illustrative events include road closures, accidents, adverse weather conditions, etc. The delivery control system 108 injects the notification information into the flow of summaries.

In another example, in response to a control instruction from the user, the delivery control system 108 interacts with a search system 120 to retrieve one or more supplemental items to be added to the flow of content provided to the user. The delivery control system 108 then interacts with the language model 110 to summarize the supplemental item(s). The delivery control system 108 then inserts the new summaries into the flow of content being delivered to the user.

For example, the delivery control system 108 can receive a request from the user for additional information regarding a news item that is currently being presented to the user. The delivery control system 108 can also receive a request from the user for additional information regarding a news item that has already been presented or is about to be presented. Such a news item is selectable, for instance, by choosing a title or other identifier of the news item from a list of content to be presented. The item that is selected is referred to as a selected item herein.

In response to the user's selection, the delivery control system 108 requests the search system 120 to retrieve one or more new news items that are semantically related to the selected item. The search system 120 performs this task using any search functionality, such as a vector-based search approach and/or a feature-based search approach (e.g., Okapi B25). A vector-based search approach converts the user-selected news item to a first hidden state vector and a candidate item to a second hidden state vector, and then uses any distance metric (e.g., cosine similarity) to assess the similarity between the two items.

The delivery control system 108 responds to other control instructions provided by a user which affect the course and content of the remaining podcast. For example, the delivery control system 108 receives a control instruction to change any one or more of: a) the natural language that the language model 110 uses to express the summaries; b) the style (tone, accent, etc.) of the summaries produced by the language model 110; c) the length of each summary; d) the frequency at which music is interjected into the stream of summaries; e) the kind of notifications which are permitted to interrupt the flow of summaries (if any); f) the timing at which notification information is inserted into the flow of summaries; g) the type of content that is summarized (e.g., indicating whether comments associated with a news item are included in the content that is summarized); h) the user accessibility characteristics of each summary, and so on. In some cases, the delivery control system 108 responds to a control instruction by modifying the system prompt that it will provide to the language model 110 upon subsequent calls to the language model. That is, the delivery control system 108 modifies one or more parameters of the prompt and/or modifies the textual instruction associated with the prompt. In other examples, the delivery control system 108 responds to a control instruction by instructing the recommendation system 106 to alter the criteria by which it selects the news items. For example, the control instruction may be an explicit request by the user to disfavor one story topic in future selections and/or favor another story topic in future selections. In other examples, the control instruction is information about the stories that the user has chosen to skip or drill down on (e.g., by asking for additional information about the stories). The recommendation system 106 interprets this information as an implicit request to favor and/or disfavor certain news items.

Upon receiving each summary, music-containing item, or notification item, the delivery control system 108 requests a converter 122 to convert that content into output information. In the case a radio podcast, the converter 122 converts each instance of content into audio information. The converter 122 can use any publicly available or application-specific text-to-speech converter to perform this task, examples of which are available at the GitHub website provided by Microsoft Corporation of Redmond, Washington. In the case of a newsletter format, given a summary or instance of content, the converter 122 produces a text section to be added to a compendium of text sections, which collectively makes up a newsletter. The converter 122 stores each instance of output information in a buffer memory 124 after it is created. When possible (e.g., in the case of a pre-selected music-containing item, ad, etc.), the delivery control system 108 converts the item into output information (e.g., audio information) in advance, prior to the time that it is requested.

An output-generating system 126 provides an output presentation based on each instance of output information stored in the buffer memory 124, and sends the output presentation to an output device 128 or to plural output devices. Examples of output devices include speakers, display devices, haptic output devices, etc. For example, in the case of an audio podcast, the output-generating system 126 streams audio signals associated with a summary to a speaker, such as the speaker of the mobile computing device 114.

In some implementations, the delivery control system 108 interrogates the buffer memory 124 after the content delivery system 102 successfully delivers a current summary. For the case in which the buffer memory 124 includes audio information for the next summary, the delivery control system 108 sends the audio information to the output-generating system 126 for output to the user. For the case in which the buffer memory 124 does not yet store a complete instance of audio information for the next summary, the delivery control system 108 retrieves a music-containing item from the sources 118. The delivery control system 108 then requests the output-generating system 126 to provide this music-containing item in lieu of the next summary. This manner of operation is advantageous because it helps ensure the delivery of an uninterrupted flow of information to the user, e.g., by reducing the chances that there will be dead air (i.e., silences) in the delivery of a radio podcast.

The delivery control system 108 can vary this manner of operation in any manner. In one variation, the delivery control system 108 requires that the buffer memory 124 store more than one instance of audio information (associated with respective summaries) prior to requesting the output-generating system 126 to deliver the summaries. In another variation, the delivery control system 108 retrieves any other type of supplemental content (not necessarily a music-containing item) upon determining that a next summary is not available. For example, the delivery control system 108 retrieves a pre-generated instance of audio information for an item of general interest (not necessarily selected by the recommendation system 106), which is presumed to be of interest to many users. For example, this item provides educational content, humorous content or other lighthearted content, a commercial or other ad-related content, news about a musician, movie star, or athlete, etc. In other examples, the pre-selected supplemental content is chosen by the recommendation system 106 to complement the interests of the user.

FIG. 1 shows an example of a stream 130 of summaries and other items provided to the user. This particular example starts with a narrative (at time t1) that provides weather information. The stream 130 then provides a sequence of three summaries (at times t3-t4) followed by a music-containing item (at time t5), followed by another three summaries (at times t6-t8), followed by another music-containing item (at time t9), followed by a notification item (e.g., which notifies the user of a nearby traffic incident) (at time t10), and so on. Each summary summarizes a news article. The content delivery system 102 produces the stream in piecemeal fashion, outputting each item when it is generated. The periodic injection of music-containing items into the steam 130 increases the variety of the stream 130, and produces a more appealing experience, e.g., by giving the listener a break from listening to news content.

Overall, the content delivery system 102 provides a single computer platform for delivering customized streams of content items to different users. This approach is flexible and scalable. The approach is flexible because it offers customized streams of content items to different users, as opposed to the alternative case in which all users consume a single fixed stream of content items. The approach is scalable insofar as it uses a single computing platform to produce the different content streams, as opposed to the alternative case in which dedicated workflows are used to produce different content streams. The scalability of the approach also makes it resource efficient. That is, using a single platform consumes less computing and memory resources compared to a platform that devotes different processes to produce different podcasts.

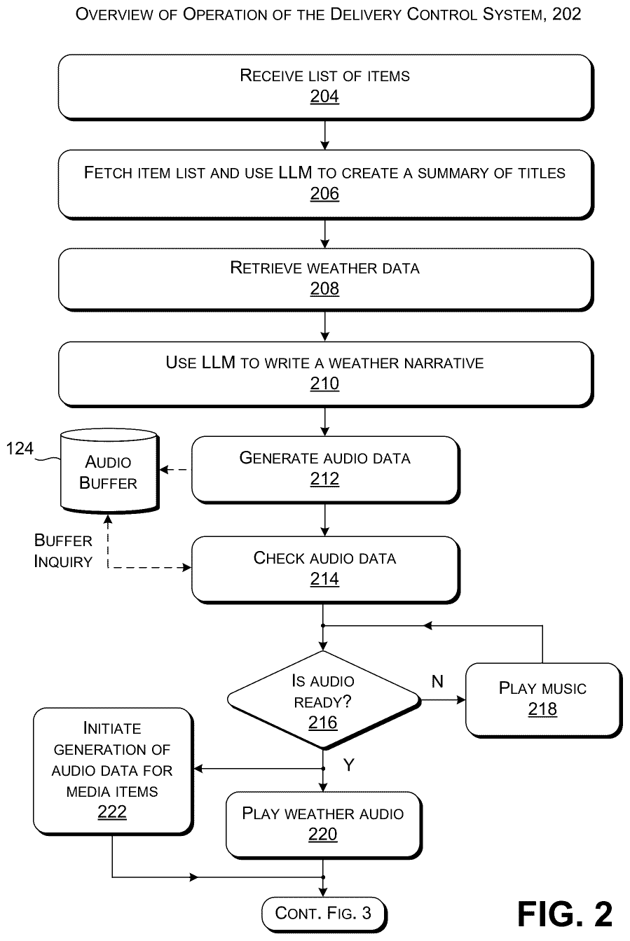

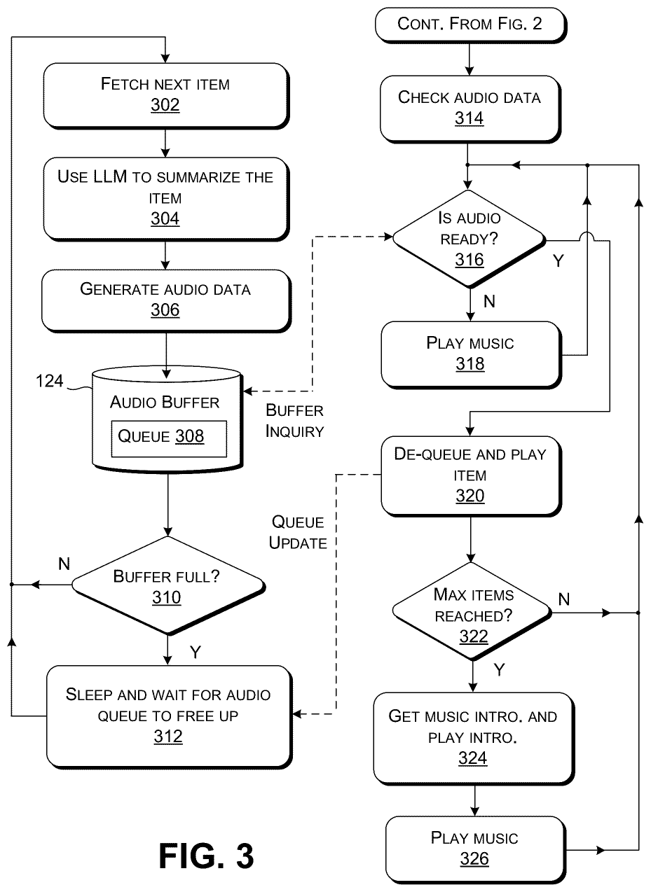

FIGS. 2 and 3 together show an illustrative flow of operations 202 by which the delivery control system 108 generates and delivers summaries to users. Generally, with respect to any of the processes described herein including FIGS. 2 and 3, each process is expressed as a series of operations performed in a particular order. But the order of these operations is illustrative and can be varied in other implementations. Further, any two or more operations described below as being performed in series are capable of being performed in a parallel manner. In addition, or alternatively, other implementations of any process described below are capable of performing additional operations and/or omitting one or more operations, compared to the operations shown in the figures. In one implementation, the blocks shown in the processes that pertain to processing-related functions are implemented by the computing equipment described in connection with FIGS. 13 and 14.

In block 204, the delivery control system 108 receives a list of items from the recommendation system 106, such as a list of news items. In block 206, the delivery control system 108 optionally interacts with the language model 110 to create summaries of the titles of the items. The delivery control system 108 can then either display the title summaries or convert the title summaries to audio information and output the audio information to a speaker.

In block 208, the delivery control system 108 requests and receives weather data from a source of weather information, based on a current location of the user. In block 210, the delivery control system 108 interacts with the language model 110 to produce a narrative that provides weather information, given the weather data that has been received. In other implementations, the operations of blocks 204 and 206 are performed in parallel with the operations of 208 and 210. This clarification applies to any description below of two or more content-processing operations being performed in series, meaning that these operations are capable of alternatively being performed in parallel.

In block 212, the delivery control system 108 interacts with the converter 122 to convert the weather narrative to audio information and store the audio information in the buffer memory 124, which in this example constitutes an audio buffer. In blocks 214 and 216, the delivery control system 108 checks the buffer memory 124 to determine whether the storage of the audio information is complete. If not, in block 218, the delivery control system 108 retrieves a music-containing item (or other supplemental item) and plays the music-containing item (or other supplemental item). On the other hand, if the audio information is ready, in block 220, the delivery control system 108 plays the weather narrative. At this juncture, as shown in block 222, the delivery control system 108 begins the process of summarizing the news items in succession. More specifically, in some examples, the process of summarizing the news items (which is initiated in block 222) can be performed in parallel with other operations shown in FIGS. 2 and 3, such as the playing of the weather narrative in block 220.

Advancing to FIG. 3, the process of summarizing the news will first be described, which is performed in a continuous loop until the podcast is terminated or the last summary has been presented. In block 302, the delivery control system 108 retrieves the next item to be summarized, which initially is the first news item. In block 304, the delivery control system 108 interacts with the language model to produce a summary of the item. In block 306, the delivery control system 108 interacts with the converter 122 to convert the summary into audio information, upon which it stores the audio information in the buffer memory 124. Overall, the buffer memory 124 maintains instances of audio information associated with different respective summaries to be played.

In block 310, the delivery control system 108 determines whether the buffer memory 124 has reached a prescribed state of fullness. For example, the delivery control system 108 determines whether the buffer memory 124 contains a prescribed number of instances of audio information and/or whether a storage capability has been reached. If the determination of block 310 is answered in the negative (meaning the buffer memory 124 is not yet full), in block 312, the delivery control system 108 repeats the above process to produce another summary and convert the summary into audio information. If this determination is answered in the affirmative, then the delivery control system 108 suspends the above-described summarization loop, and then waits for the playback process to play the summaries and decrement the queue 308.

Now referring to that playback process, in blocks 314 and 316, the delivery control system 108 checks the buffer memory 124 to determine whether the buffer memory 124 has reached a prescribed test of fullness, e.g., by determining whether the buffer memory 124 stores a complete instance of audio information (for a summary) to be played back. If this state of fullness is not reached, in block 318, the delivery control system 108 plays a music-containing item (or other supplemental item), and then returns to blocks 314 and 316 to check the buffer memory 124 again. If block 316 is answered in the affirmative (meaning that the audio information is ready), then, in block 320, the delivery control system 108 plays audio information for a summary and decrements the queue 308.

In block 322, the delivery control system 108 determines whether a predetermined number of summaries have been presented. In the illustrative stream 130 of FIG. 1, the predetermined number is three summaries. If the predetermined number has not been reached, then the delivery control system 108 repeats the above-described playback loop. If block 322 is answered in the affirmative, then, in block 324, the delivery control system 108 optionally asks the language model 110 to rephrase a short textual introduction to the music or other supplemental item. This is implemented by giving the language model 110 a stock introduction and instructing the language model 110 to change the wording of it. This aspect introduces variety in the podcast, as a slightly different introduction will be provided prior to each music-containing item or other supplemental item. The delivery control system 108 can achieve a similar effect by randomly selecting from a data store that provides a set of different pre-generated introductions.

The delivery control system 108 interacts with the converter 122 to convert the introduction into audio information, and then, in block 326, plays the introduction followed by a music-containing item.

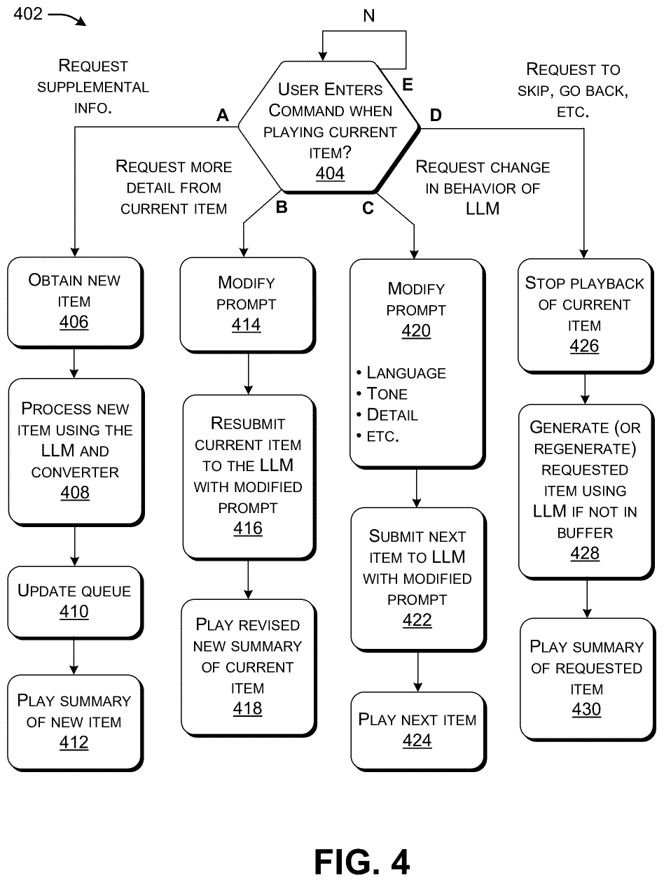

FIG. 4 shows a process 402 that demonstrates how the delivery control system 108 responds to different control instructions provided by the user. In block 404, the delivery control system 108 determines whether the user has entered a command. Paths A-D show different flows of operations that the delivery control system 108 performs for different kinds of received commands. Path E is a feedback path that is taken when no command is received.

In path A, assume that the user makes a request for more detail regarding a summary that is currently being played or a summary that has previously played. The user can specify this selection via a graphical user interface presentation (GUI) or via a voice command. This item is referred to as the selected item below. In block 406, the delivery control system 108 interacts with the search system 120 to obtain a new item that is semantically related to the selected item. In block 408, the delivery control system 108 interacts with the language model 110 to summarize the new item, and then interacts with the converter 122 to convert the resultant summary into audio information. In block 410, the delivery control system 108 updates the queue 308 to include the summary as the next item to be played. In block 412, the delivery control system 108 plays the summary of the new item. The user can ask for more detail any number of times, and thereby effectively “drill down” on any topic of interest, e.g., by requesting more information about the new item itself.

In path B, assume that the user requests that the delivery control system 108 extract more information from a selected item itself, rather than finding and playing a supplemental item related to the selected item. In block 414, the delivery control system 108 modifies the prompt, e.g., by changing a parameter in the prompt that governs how much detail is to be extracted from a news item in producing a summary of the news item. In block 416, the delivery control system 108 resubmits the selected item to the language model 110, via the modified prompt. The delivery control system 108 receives a summary in response to the prompt and uses the converter 122 to convert the summary into audio information. In block 418, the delivery control system 108 plays the summary.

In path C, assume that the user specifies another modification to be made to the way that the language model 110 produces summaries. For instance, assume that the user specifies that a change be made to any one or more of: a) the style (e.g., tone) used by the language model 110 in producing summaries; b) the language used by the language model 110; c) the level of detail that the language model 110 uses in summarizing the items, and so on. In block 420, the delivery control system 108 modifies one or more parameters of the prompt based on the user's instructions. In block 422, the delivery control system 108 submits a next item to the language model 110 via the modified prompt, receives a summary in response thereto, and subsequently uses the converter 122 to convert the resultant summary into audio information. In block 424, the delivery control system 108 plays the summary.

Although not represented by path C, the delivery control system 108 alternatively, or in addition, sends control instructions to the recommendation system 106, which governs the manner in which the recommendation system 106 selects subsequent news items. The control information is based on the explicit and/or implicit behavior of the user. An example of explicit behavior is an explicit request by the user to change the criteria by which news items are selected. An example of implicit behavior is the user's interaction with prior news items (e.g., by skipping a news item), from which appropriate selection criteria can be inferred.

In path D, assume that the user requests the delivery control system 108 to replay a previously-played summary, or to play a summary that is scheduled to play in the future. In block 426, the delivery control system 108 stops the playback of the current summary. In block 428, the delivery control system 108 produces the requested instance of audio information. That is, in a first case, the delivery control system 108 determines that the requested instance of audio information has already been stored in the buffer memory 124, upon which the delivery control system 108 accesses that information. In a second case, the audio information is not immediately available. Here, the delivery control system 108 interacts with the language model 110 to generate or regenerate the requested summary, and then uses the converter 122 to convert the requested summary into audio information. The delivery control system 108 plays a music-containing item until the requested audio information is available. In block 430, the delivery control system 108 plays the requested audio information.

The above control operations are illustrative. Other implementations introduce additional process flows in response to other control instructions, and/or omit one or more of the process flows described above.

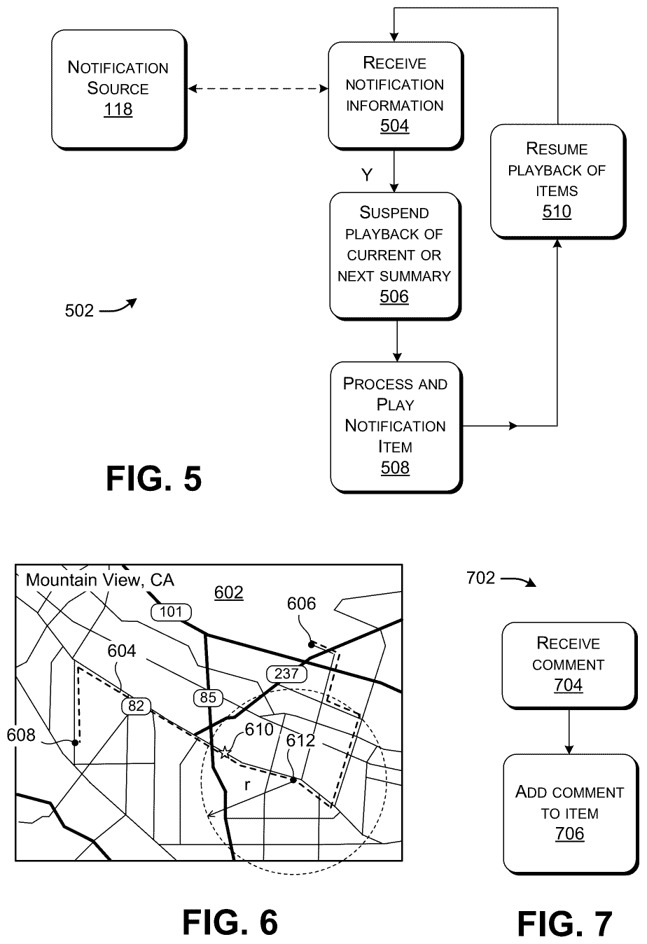

FIG. 5 shows process 502 for inserting a notification item into a stream of summaries in response to the occurrence of an event of interest. In block 504, the delivery control system 108 receives a message pushed from a notification source, indicating that an event of interest has occurred. Alternatively, the delivery control system 108 periodically polls the notification source to determine whether any event of interest has occurred. Assuming that an event has occurred, the delivery control system 108 receives notification information from the notification source.

In block 506, the delivery control system 108 interrupts the playback of any in-progress summary or waits until the in-progress summary has completed. The choice between these two options depends on a configuration setting and/or based on a severity level associated with the event that has occurred. In block 508, the delivery control system 108 processes and plays a notification item. This optionally involves interacting with the language model 110 to produce a summary of the received notification information and then play the summary (after converting it to audio information). In block 510, the delivery control system 108 resumes its generation and playing of summaries of news items.

FIG. 6 shows a map 602 of a route 604 between a user-selected starting location 606 and ending location 608. Assume that a route-planning system automatically produces the route based on any route-selecting algorithm. Examples of route-selecting algorithms include Dijkstra's algorithm, the A* algorithm, the Floyd-Warshall algorithm, Johnson's algorithm, the Customizable Route Planning (CRP) algorithm (described, for instance, in Delling, et al., “Customizable Route Planning,” in Proceedings of the 10th International Symposium on Experimental Algorithms (SEA'11), May 2011, 12 pages), and so on. Machine-trained models for assisting in the task of route planning include various supervised techniques and reinforcement learning techniques, e.g., as described in Bogyrbayevay, et al., “Learning to Solve Vehicle Routing Problems: A Survey,” arXiv, arXiv:2205.02453v1 [cs.LG], May 5, 2023, May 2022, 21 pages.

Assume that the notification source is a traffic alert system that identifies the occurrence of traffic events of interest, including accidents, road closures, traffic backups, and/or adverse weather conditions, etc. Further assume that, in this specific example: (a) the notification source identifies that an accident has occurred at a location 610, causing traffic to back up; (b) the context-supplying system 112 identifies the user's current location 612 (e.g., based on GPS information provided by a GPS device); and (c) the context-supplying system 112 determines that the location 610 of the accident is within a prescribed threshold radius r of the user's current location 612. Based on these determinations, the delivery control system 108 triggers the presentation of a notification item that alerts the user of the existence of the accident. In addition, the delivery control system 108 optionally requests the route-planning system to produce and present a new route which bypasses the accident.

FIG. 6 also serves as a basis for explaining another capability of the content delivery system 102. Assume that, in addition to recommending the route 604, the route-planning system estimates the amount of time it will take to traverse the route 604. The route-planning system performs this task based on: (a) metadata stored in a map database that specifies speed limits and other rules associated with the roads that make up the route 604; (b) the distance that the user will travel on each road; and (c) traffic data that identifies the current traffic conditions on each road. Based on this data, the route-planning system determines the amount of time it will take to traverse each leg of the route 604. The route-planning system determines the amount of time that will take to traverse the entire route 604 by aggregating the per-leg durations. The duration of the trip constitutes a target duration. Assume that the target duration in the example of FIG. 6 is thirty minutes.

The delivery control system 108 chooses the length of the podcast to generally match the target duration. In the example of FIG. 6, the delivery control system 108 selects a length of thirty minutes for the podcast. The delivery control system 108 produces a podcast of desired length by: a) selecting the number of summaries that will be included in the podcast; and/or b) selecting the length of each summary.

FIG. 7 shows a process 702 for handling the receipt of a user comment. Assume that the user is currently listening to a summary of a news item and decides to make a comment regarding the news item. In block 704, a microphone (not shown) provided by the mobile computing device 114 receives the comment. In block 706, the delivery control system 108 posts the comment to whatever service provides the original news item. The content delivery system 102 also exposes the user to the existing comments associated with a news item. For example, the user may choose a configuration setting that causes the delivery control system 108 to present comments associated with each summary, or summarized versions of the comments. Alternatively, the user may issue a voice command during the playing of a summary that instructs the delivery control system 108 to play the comments regarding the news item after the summary is read out. The delivery control system 108 processes this request using the control flow of path B shown in FIG. 6.

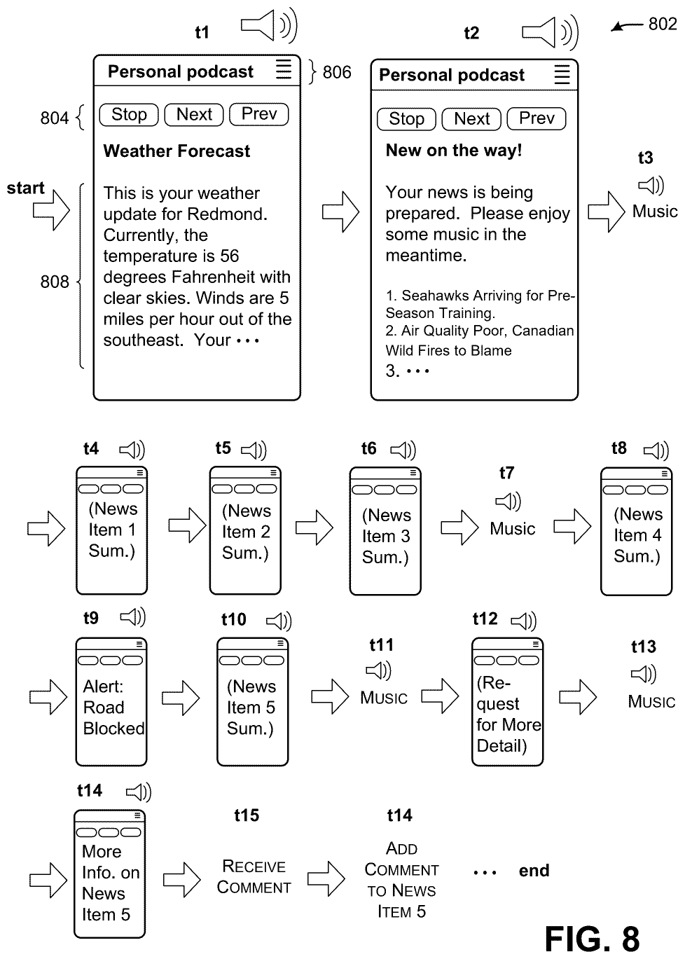

FIG. 8 shows an example 802 of a sequence of personalized audio presentations produced by the content delivery system 102 of FIG. 1. In this illustrative case, the content delivery system 102 provides each summary in visual text form and audio form. The visual text may be viewed as a transcript of the audio content. In other examples, the content delivery system 102 provides just text information in visual form or audio form, but not both.

The user starts the podcast by clicking on a podcast application icon and issuing a start command. Or the user may issue voice commands to the same effect. At time t1, the content delivery system 102 provides weather information. Generally, a graphical control 804 enables a user to navigate within a list of items. A graphical control 806 invokes a window by which the user may enter other control instructions, e.g., by changing the tone or language of the summaries. A section 808 presents a summary. All of these controls and sections have audio counterparts.

At time t2, the content delivery system 102 optionally provides information about the sequence of news items to follow, e.g., by providing a list of summarized titles of those news items. At time t3, the content delivery system 102 plays music because the first summary is not yet ready for presentation.

At times t4-t6, the content delivery system 102 successively plays three summaries associated with three respective news items. At time t7, the content delivery system 102 plays a musical interlude. At times t8-t11, the content delivery system 102 repeats the above series of actions, e.g., by successively presenting three more summaries followed by a musical interlude.

At time t12, assume that the user requests more information about the last-played summary (at time t10). In response, at time t13, the content delivery system 102 plays a musical selection while it retrieves and processes a new item that is semantically related to the last-played summary. At time t14, the content delivery system 102 plays a summary of the new item.

At time t15, the content delivery system 102 receives a comment from the user about the new item presented at time t14. At time t16, the content delivery system 102 posts the comment to whatever service publishes the news item.

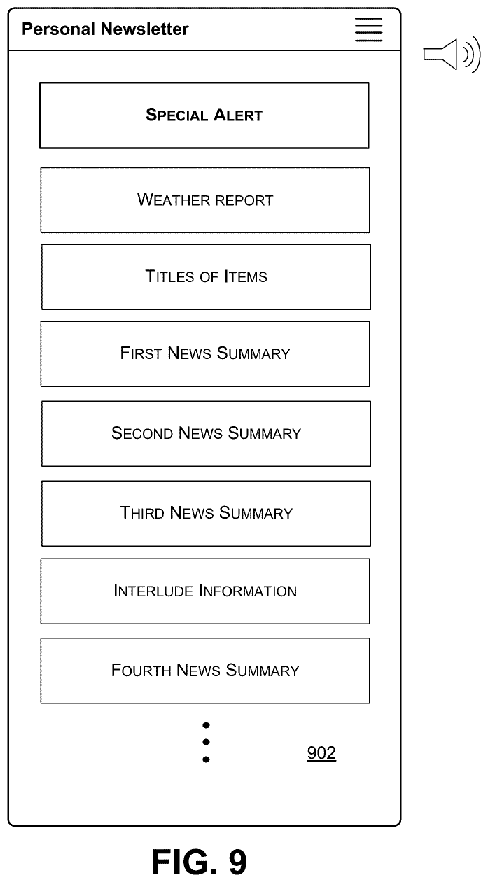

FIG. 9 shows an example of a collection of text summaries produced by the content delivery system 102 of FIG. 1, which collectively make up a personalized newsletter 902. The content delivery system 102 successively compiles the newsletter 902 as the sections become available. The content delivery system 102 provides the newsletter 902 to a user in piecemeal fashion as the sections are added to the newsletter 902. Alternatively, the content delivery system 102 provides the newsletter 902 to the user only after it is complete. The content delivery system 102 provides the newsletter to the user via any communication channel, including an Email message, news feed, etc.

The newsletter 902 includes a sequence of the same kinds of entries as the example 802 of FIG. 8, In the case of FIG. 9, however, these entries are presented in a single compendium of information. For instance, the newsletter 902 includes sections devoted to alerts, weather information, news summaries, interlude information, etc. Each instance of interlude information is the textual counterpart of a musical selection. A textual instance of interlude information, for example, includes a lighthearted story of interest, a story about a pop star or sports figure, a puzzle, etc. The interlude information is user agnostic or chosen to complement the interests of a particular user.

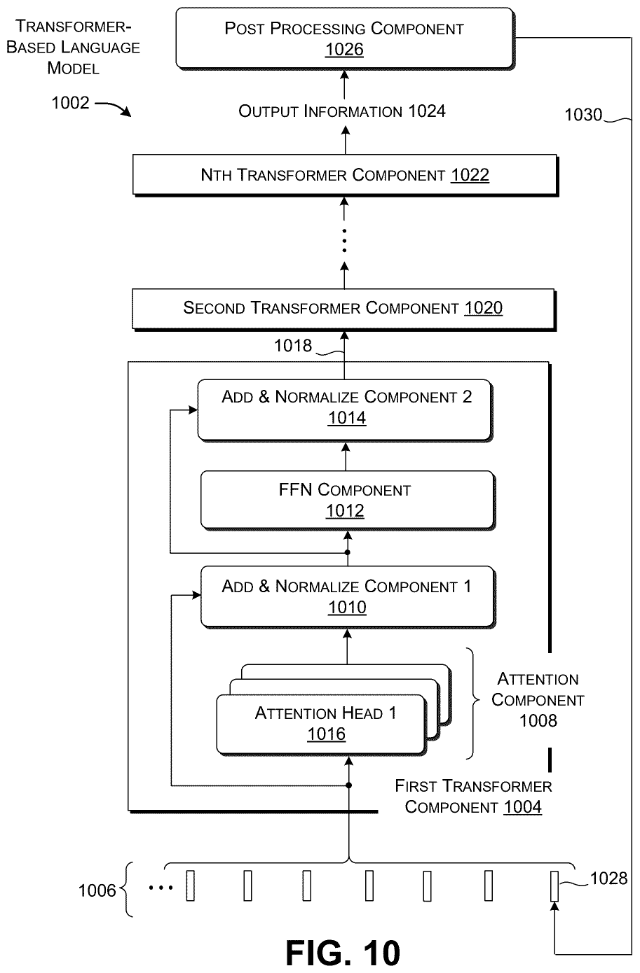

FIG. 10 shows a transformer-based language model (“language model”) 1002 for implementing the recommendation model and/or the language model 110 used by the content delivery system 102 of FIG. 1. In some implementations, the language model 1002 operates by autoregressively generating output tokens in response to a prompt. The ChatGPT model is an example this type of language model. In another example, the language model 1002 maps input information into output information in a single pass. The BERT model is an example of this type of language model.

The language model 1002 is composed, in part, of a pipeline of transformer components, including a first transformer component 1004. FIG. 10 provides details regarding one way to implement the first transformer component 1004. Although not specifically illustrated, other transformer components of the language model 1002 have the same architecture and perform the same functions as the first transformer component 1004 (but are governed by separate sets of weights).

The language model 1002 commences its operation with the receipt of input information, such as a prompt. The input information includes a series of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. The principles set forth herein, however, are not limited to the processing of text information; in other examples, the language model 1002 operates on any of: audio information, image information, video information, sensor information, and so on, or any combination thereof.

Next, an embedding component (not shown) maps the sequence of text tokens into respective token embeddings. For example, the embedding component produces one-hot vectors that describe the tokens, and then maps the one-hot vectors into the text token embeddings using a machine-trained linear transformation. The embedding component then adds position information (and, in some cases, segment information) to the respective token embeddings to produce position-supplemented embedding vectors 1006. The position information added to each token embedding describes the embedding vector's position in the sequence of token embeddings.

The first transformer component 1004 operates on the position-supplemented embedding vectors 1006. In some implementations, the first transformer component 1004 includes, in order, an attention component 1008, a first add-and-normalize component 1010, a feed-forward neural network (FFN) component 1012, and a second add-and-normalize component 1014.

The attention component 1008 determines how much emphasis should be placed on parts of input information when interpreting other parts of the input information. Consider, for example, a sentence that reads: “I asked the professor a question, but he could not answer it.” When interpreting the word “it,” the attention component 1008 will determine how much weight or emphasis should be placed on each of the words of the sentence. The attention component 1008 will find that the word “question” is most significant.

The attention component 1008 performs attention analysis using the following equation:

$$Attention ( Q , K , V ) = soft max ( \frac{{QK}^{T}}{\sqrt{d}} ) V . \qquad ( 1 )$$

The attention component 1008 produces query information Q by multiplying the position-supplemented embedding vectors 1006 by a query weighting matrix W^{Q}. Similarly, the attention component 1008 produces key information K and value information V by multiplying the position-supplemented embedding vectors 1006 by a key weighting matrix W^{K} and a value weighting matrix W^{V}, respectively. To execute Equation (1), the attention component 1008 takes the dot product of Q with the transpose of K, and then divides the dot product by a scaling factor \sqrt{d}, to produce a scaled result. The symbol d represents the dimensionality of Q and K. The attention component 1008 takes the Softmax (normalized exponential function) of the scaled result, and then multiplies the result of the Softmax operation by V, to produce attention output information. In some cases, the attention component 1008 is said to perform masked attention insofar as the attention component 1008 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 10 shows that the attention component 1008 is composed of plural attention heads, including a representative attention head 1016. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1008 concatenates the output results of the attention component's separate attention heads, and then multiplies the results of this concatenation by another weight matrix W\hat{ }O.

The add-and-normalize component 1010 includes a residual connection that combines (e.g., sums) input information fed to the attention component 1008 with the output information generated by the attention component 1008. The add-and-normalize component 1010 then normalizes the output information generated by the residual connection, e.g., by layer-normalizing values in the output information based on the mean and standard deviation of those values, or by performing root-mean-squared normalization. The other add-and-normalize component 1014 performs the same functions as the first-mentioned add-and-normalize component 1010. The FFN component 1012 transforms input information to output information using a feed-forward neural network having any number of layers.

The first transformer component 1004 produces output information 1018. A series of other transformer components (1020, . . . , 1022) perform the same functions as the first transformer component 1004, each operating on output information produced by its immediately preceding transformer component. Each transformer component uses its own level-specific set of machine-trained weights. The final transformer component 1022 in the language model 1002 produces final output information 1024.

In some implementations, a post-processing component 1026 performs post-processing operations on the final output information 1024. For example, the post-processing component 1026 includes a feed-forward neural network that maps the final output information 1024 to output logits, and a softmax operation that maps the logits to a prediction or classification result. In the context of the recommendation model used by the recommendation system 106, assume that the input information fed to the language model 1002 is a concatenation of feature information that describes the characteristics of a user and text that describes a candidate item. Here, the post-processing component 1026 produces a classification result that specifies whether the candidate item is relevant to the interests of the user and thus should be added to the sequence of items presented to the user.

In the context of an autoregressive summarization model, assume that the input information is a prompt that provides the text of a particular news item and an instruction to summarize the news item in a desired natural language. The language model 1002 uses the output of the post-processing component 1026 to predict the next token in the input sequence of tokens. The language model 1002 then appends the predicted token to the end of the sequence of input tokens, to provide an updated sequence of tokens. The predicted token leads to the production of a new position-supplemented vector 1028. In a next pass, the language model 1002 processes the updated sequence of position-supplemented vectors to generate a next predicted token. The language model 1002 repeats the above process until it generates a specified stop token. FIG. 10 summarizes this manner of operation with a loop 1030.

The above-described implementation of the language model 1002 relies on a decoder-only architecture. Other implementations of the language model 1002 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component).

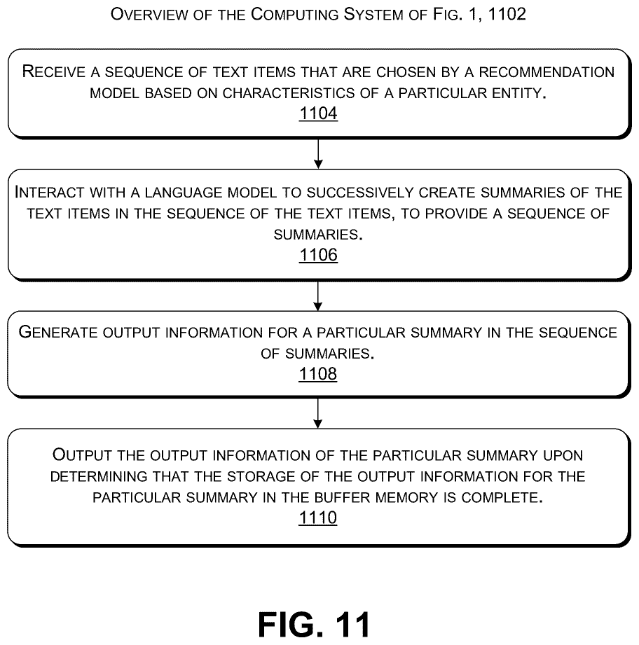

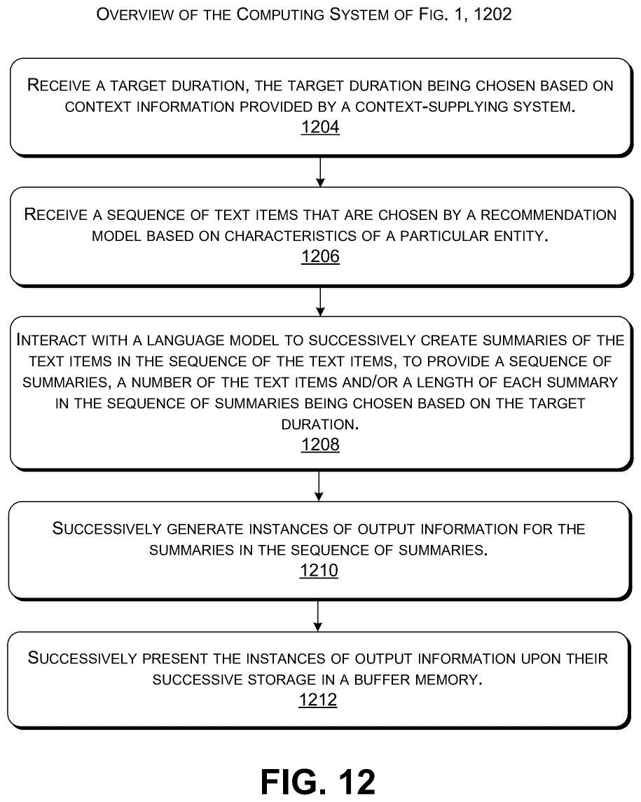

FIGS. 11 and 12 show two processes that represent an overview of the operation of the content delivery system 102 of FIG. 1. More specifically, FIG. 11 shows a process 1102 performed by the content delivery system 102 for controlling the delivery of items. In block 1104, the delivery control system 108 receives a sequence of text items that are chosen by a recommendation model (e.g., the recommendation system 106) based on characteristics of a particular entity. In block 1106, the content delivery system 102 interacts with a language model (e.g., the language model 110) to successively create summaries of the text items in the sequence of the text items, to provide a sequence of summaries. In block 1108, the content delivery system 102 generates output information (e.g., audio information) for a particular summary in the sequence of summaries. In block 1110, the content delivery system 102 presents the output information of the particular summary upon determining that storage of the output information for the particular summary in a buffer memory (e.g., the buffer memory 124) is complete. Prior to reaching this determination, the content-delivery system 102 presents output information for a preparatory item (e.g., a music-containing item). A preparatory item is an item that the content delivery system 102 presents while output information for other content (e.g., news items) is being prepared for presentation.

FIG. 12 shows another process 1202 performed by the content delivery system 102 for controlling the delivery of items. In block 1204, the content delivery system 102 receives a target duration, the target duration being chosen based on context information provided by a context-supplying system (e.g., the context-supplying system 112). For instance, assume that a route-planning system identifies a duration of a trip that the user is planning to take. This trip duration constitutes the target duration. In block 1206, the content delivery system 102 receives a sequence of text items that are chosen by a recommendation model (e.g., the recommendation system 106) based on characteristics of a particular entity. In block 1208, the content delivery system 102 interacts with a language model (e.g., the language model 110) to successively create summaries of the text items in the sequence of the text items, to provide a sequence of summaries. A number of text items and/or a length of each summary in the sequence of summaries are chosen based on the target duration. In block 1210, the content delivery system 102 successively generates instances of output information for the summaries in the sequence of summaries. In block 1212, the content delivery system 102 successively presents the instances of output information upon their successive storage in a buffer memory (e.g., the buffer memory 124).

FIG. 13 shows computing equipment 1302 that, in some implementations, is used to implement the content delivery system 102. The computing equipment 1302 includes a set of local devices 1304 coupled to a set of servers 1306 via a computer network 1308. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1308 is implemented as a local area network, a wide area network (e.g., the Internet), one or more point-to-point links, or any combination thereof.

The bottom-most overlapping box in FIG. 13 indicates that the functionality of the content delivery system 102 is capable of being spread across the local devices 1304 and/or the servers 1306 in any manner. In one example, the content delivery system 102 is entirely implemented by a local device, or entirely implemented by the servers 1306. In the latter case, each user interacts with the servers 1306 via browsers provided by respective local devices. In other examples, some of the functions of the content delivery system 102 are implemented by a local device, and other functions of the content delivery system 102 are implemented by the servers 1306. For instance, the language model 110 is implemented by the servers 1306, and the remainder of the functions of the content delivery system 102 are implemented by each local device.

FIG. 14 shows a computing system 1402 that, in some implementations, is used to implement any aspect of the mechanisms set forth in the above-described figures. For instance, in some implementations, the type of computing system 1402 shown in FIG. 14 is used to implement any local computing device or any server shown in FIG. 13. In all cases, the computing system 1402 represents a physical and tangible processing mechanism.

The computing system 1402 includes a processing system 1404 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1402 also includes computer-readable storage media 1406, corresponding to one or more computer-readable media hardware units. The computer-readable storage media 1406 retains any kind of information 1408, such as machine-readable instructions, settings, model weights, and/or other data. In some implementations, the computer-readable storage media 1406 includes one or more solid-state devices, one or more hard disks, one or more optical disks, etc. Any instance of the computer-readable storage media 1406 represents a fixed or removable unit of the computing system 1402. Further, any instance of the computer-readable storage media 1406 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1402 utilizes any instance of the computer-readable storage media 1406 in different ways. For example, in some implementations, any instance of the computer-readable storage media 1406 represents a hardware memory unit (such as random access memory (RAM)) for storing information during execution of a program by the computing system 1402, and/or a hardware storage unit (such as a hard disk) for retaining/archiving information on a more permanent basis. In the latter case, the computing system 1402 also includes one or more drive mechanisms 1410 (such as a hard drive mechanism) for storing and retrieving information from an instance of the computer-readable storage media 1406.

In some implementations, the computing system 1402 performs any of the functions described above when the processing system 1404 executes computer-readable instructions stored in any instance of the computer-readable storage media 1406. For instance, in some implementations, the computing system 1402 carries out computer-readable instructions to perform each block of the processes described with reference to FIGS. 11 and 12. FIG. 14 generally indicates that hardware logic circuitry 1412 includes any combination of the processing system 1404 and the computer-readable storage media 1406.

In addition, or alternatively, the processing system 1404 includes one or more other configurable logic units that perform operations using a collection of logic gates, such as field-programmable gate arrays (FPGAs), etc. In these implementations, the processing system 1404 effectively incorporates a storage device that stores computer-readable instructions, insofar as the configurable logic units are configured to execute the instructions and therefore embody or store these instructions.

In some cases (e.g., in the case in which the computing system 1402 represents a user computing device), the computing system 1402 also includes an input/output interface 1414 for receiving various inputs (via input devices 1416), and for providing various outputs (via output devices 1418). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1420 and an associated graphical user interface presentation (GUI) 1422. The display device 1420 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1402 also includes one or more network interfaces 1424 for exchanging data with other devices via one or more communication conduits 1426. One or more communication buses 1428 communicatively couple the above-described units together.

The communication conduit(s) 1426 is implemented in any manner, e.g., by a local area computer network, a wide area computer network (e.g., the Internet), point-to-point connections, or any combination thereof. The communication conduit(s) 1426 include any combination of hardwired links, wireless links, routers, gateway functionality, name servers, etc., governed by any protocol or combination of protocols.

FIG. 14 shows the computing system 1402 as being composed of a discrete collection of separate units. In some cases, the collection of units corresponds to discrete hardware units provided in a computing device chassis having any form factor. FIG. 14 shows illustrative form factors in its bottom portion. In other cases, the computing system 1402 includes a hardware logic unit that integrates the functions of two or more of the units shown in FIG. 14. For instance, in some implementations, the computing system 1402 includes a system on a chip (SoC or SOC), corresponding to an integrated circuit that combines the functions of two or more of the units shown in FIG. 14.

The following summary provides a set of illustrative examples of the technology set forth herein.

(A1) According to one aspect, a method (e.g., the process 1102) is described for controlling the delivery of items. The method includes: receiving (e.g., in block 1104) a sequence of text items that are chosen by a recommendation model based on characteristics of a particular entity; interacting (e.g., in block 1106) with a language model (e.g., the language model 110) to successively create summaries of the text items in the sequence of the text items, to provide a sequence of summaries; generating (e.g., in block 1108) output information for a particular summary in the sequence of summaries; and presenting (e.g., in block 1110) the output information of the particular summary upon determining that storage of the output information for the particular summary in a buffer memory (e.g., the buffer memory 124) is complete.

(A2) According to some implementations of the method of A1, the generating of the output information for the particular summary includes converting text associated with the particular summary into audio information. The presenting of the output information for the particular summary includes playing the audio information.

(A3) According to some implementations of the methods of A1 or A2,method further includes, prior to determining that the output information for the particular summary in the buffer memory is complete, presenting output information for a preparatory item, the preparatory item being content that is presented while the output information for the particular summary is being prepared.

(A4) According to some implementations of the method of A3, the sequence of text items is a sequence of news items that match the characteristics of the entity, as determined by the recommendation model, and the preparatory item is a music-containing item.

(A5) According to some implementations of any of the methods of A1-A4, the generating of the output information for the particular summary includes generating a text section to be added to a textual compendium of text sections associated with the sequence of summaries.

(A6) According to some implementations of any of the methods of A1-A5, the method further includes, prior to generating output information for a first summary in the sequence of summaries: obtaining weather data from a source of weather information; interacting with the language model to produce a text narrative based on the weather data; and generating and presenting output information for the text narrative.

(A7) According to some implementations of any of the methods of A1-A6, the interacting with the language model includes, for the particular text item: generating a prompt that contains the particular text item and an instruction to summarize the particular text item; submitting the prompt to the language model; and receiving the particular summary from the language model, the particular summary being generated by the language model in response to the prompt.

(A8) According to some implementations of any of the methods of A1-A7, the method further includes: receiving a control instruction during generating and presenting instances of output information for the sequence of summaries; and modifying the sequence of summaries based on the control instruction.

(A9) According to some implementations of the method of A8, for one type of control instruction, the modifying includes: obtaining a supplemental text item that is semantically related to the particular summary, the supplemental text item not being among the sequence of text items; interacting with the language model to create a summary of the supplemental text item; and generating output information for the summary of the supplemental text item and presenting the output information for the summary of the supplemental item.

(A10) According to some implementations of any of the methods of A8 or A9, at least one summary in the sequence of summaries is produced by the language model based on initial control settings that specifies: an initial level of detail, an initial style of presentation, and an initial natural language. The modifying includes: changing one or more of the initial level of detail, the initial style of presentation, and/or the initial natural language, to produce updated control settings; and interacting with the language model to produce summaries using the updated settings.

(A11) According to some implementations of any of the methods of A1-A10, the method further includes, during generating and presenting of instances of output information for the sequence of summaries: receiving notification information that provides a notice that an event has occurred; generating a notification item based on the notification information; and interrupting the generating and presenting to present output information that is produced based on the notification item.

(A12) According to some implementations of the method of A11, the method further includes receiving an indication of a current location of the entity and a location of the event, and determining that the location of the event is within a prescribed distance of the current location of the entity.

(A13) According to some implementations of any of the methods of A1-A12, the method further includes receiving an estimate of a duration of a journey that the entity is taking or about to take; and choosing a number of the text items and/or a length of each summary in the sequence of summaries based on the duration of the journey.

(A14) According to some implementations of any of the methods of A1-A13, according to one configuration setting, the summary of the particular item includes a summary of at least one comment associated with the particular item.

(A15) According to some implementations of any of the methods of A1-A14, the method further includes: receiving a comment from the entity pertaining to the particular summary; and adding the comment to the particular text item in response to receiving the comment.

In yet another aspect, some implementations of the technology described herein include a computing system (e.g., the computing system 1402) that includes a processing system (e.g., the processing system 1404) having a processor. The computing system also includes a storage device (e.g., the computer-readable storage media 1406) for storing computer-readable instructions (e.g., the information 1408).

The processing system executes the computer-readable instructions to perform any of the methods described herein (e.g., any individual method of the methods of A1-A15).

In yet another aspect, some implementations of the technology described herein include a computer-readable storage medium (e.g., the computer-readable storage media 1406) for storing computer-readable instructions (e.g., the information 1408). A processing system (e.g., the processing system 1404) executes the computer-readable instructions to perform any of the operations described herein (e.g., the operations in any individual method of the methods of A1-A15).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted.

Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1412 of FIG. 14. The term “logic” likewise encompasses various physical and tangible mechanisms for performing a task. For instance, each processing-related operation illustrated in the flowcharts of FIGS. 11 and 12 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by a computing system, for controlling the delivery of items, comprising:
receiving a sequence of text items that are chosen by a recommendation model based on characteristics of a particular entity;
interacting with a language model to successively create summaries of the text items in the sequence of the text items, to provide a sequence of summaries;
generating output information for a particular summary in the sequence of summaries; and
presenting the output information of the particular summary upon determining that storage of the output information for the particular summary in a buffer memory is complete.

2. The method of claim 1,
wherein the generating of the output information for the particular summary includes converting text associated with the particular summary into audio information, and
wherein the presenting of the output information for the particular summary includes playing the audio information.

3. The method of claim 1, further comprising, prior to determining that the output information for the particular summary in the buffer memory is complete, presenting output information for a preparatory item, the preparatory item being content that is presented while the output information for the particular summary is being prepared.

4. The method of claim 3, wherein the sequence of text items is a sequence of news items that match the characteristics of the entity, as determined by the recommendation model, and wherein the preparatory item is a music-containing item.

5. The method of claim 1, wherein the generating of the output information for the particular summary includes generating a text section to be added to a textual compendium of text sections associated with the sequence of summaries.

6. The method of claim 1, further comprising, prior to generating output information for a first summary in the sequence of summaries:
obtaining weather data from a source of weather information;
interacting with the language model to produce a text narrative based on the weather data; and
generating and presenting output information for the text narrative.

7. The method of claim 1, wherein the interacting with the language model includes, for the particular text item:
generating a prompt that contains the particular text item and an instruction to summarize the particular text item;
submitting the prompt to the language model; and
receiving the particular summary from the language model, the particular summary being generated by the language model in response to the prompt.

8. The method of claim 1, further comprising:
receiving a control instruction during generating and presenting instances of output information for the sequence of summaries; and
modifying the sequence of summaries based on the control instruction.

9. The method of claim 8, wherein, for one type of control instruction, the modifying includes:
obtaining a supplemental text item that is semantically related to the particular summary, the supplemental text item not being among the sequence of text items;
interacting with the language model to create a summary of the supplemental text item; and
generating output information for the summary of the supplemental text item and presenting the output information for the summary of the supplemental item.

10. The method of claim 8,
wherein at least one summary in the sequence of summaries is produced by the language model based on initial control settings that specifies: an initial level of detail, an initial style of presentation, and an initial natural language; and
wherein the modifying includes:
changing one or more of the initial level of detail, the initial style of presentation, and/or the initial natural language, to produce updated control settings; and
interacting with the language model to produce summaries using the updated settings.

11. The method of claim 1, further comprising, during generating and presenting of instances of output information for the sequence of summaries:
receiving notification information that provides a notice that an event has occurred;
generating a notification item based on the notification information; and
interrupting the generating and presenting to present output information that is produced based on the notification item.

12. The method of claim 11, further comprising receiving an indication of a current location of the entity and a location of the event, and determining that the location of the event is within a prescribed distance of the current location of the entity.

13. The method of claim 1, further comprising:
receiving an estimate of a duration of a journey that the entity is taking or about to take; and
choosing a number of the text items and/or a length of each summary in the sequence of summaries based on the duration of the journey.

14. The method of claim 1, wherein, according to one configuration setting, the summary of the particular item includes a summary of at least one comment associated with the particular item.

15. The method of claim 1, further comprising:
receiving a comment from the entity pertaining to the particular summary; and
adding the comment to the particular text item in response to receiving the comment.

16. A computing system for controlling delivery of items in a personalized audio podcast, comprising:
an instruction data store for storing computer-readable instructions; and
a processing system for executing the computer-readable instructions in the data store, to perform operations including:
receiving a sequence of text items that are chosen by a recommendation model based on characteristics of a particular entity;
interacting with a language model to successively create summaries of the text items in the sequence of the text items, to provide a sequence of summaries;
generating audio information for a particular summary in the sequence of summaries; and
playing the audio information for the particular summary upon determining that storage of the audio information for the particular summary in a buffer memory is complete.

17. The computing system of claim 16, wherein the operations further comprise, prior to generating of audio information for a first summary in the sequence of summaries:
obtaining weather data for a current location of the entity from a source of weather information;
interacting with the language model to produce a text narrative based on the weather data; and
generating and playing audio information for the narrative.

18. The computing system of claim 16, wherein the operations further include modifying the sequence of summaries in response to a control instruction by:
obtaining a supplemental text item that is semantically related to the particular summary, the supplemental text item not being among the sequence of text items;
interacting with the language model to create a summary of the supplemental text item; and
generating audio information for the summary of the supplemental text item and presenting the audio information for the summary of the supplemental item.

19. A computer-readable storage medium for storing computer-readable instructions, a processing system executing the computer-readable instructions to perform operations, the operations comprising each of:
receiving a target duration, the target duration being chosen based on context information provided by a context-supplying system;
receiving a sequence of text items that are chosen by a recommendation model based on characteristics of a particular entity;
interacting with a language model to successively create summaries of the text items in the sequence of the text items, to provide a sequence of summaries, a number of the text items and/or a length of each summary in the sequence of summaries being chosen based on the target duration;
successively generating instances of output information for the summaries in the sequence of summaries; and
successively presenting the instances of output information upon their successive storage in a buffer memory.

20. The computer-readable storage medium of claim 19, wherein the context-supplying system specifies a journey that the entity is taking or about to take, and wherein the target destination is selected based on an estimate of a duration of the journey.
